(19) United States
(12) Patent Application Publication
(10) Pub. No.: US 2017/0290295 A1
(43) Pub. Date: Oct. 12, 2017

(54) Animal Training System

(71) Applicant: Dennis Quesnel, Uxbridge (CA)

(72) Inventor: Dennis Quesnel, Uxbridge (CA)

(21) Appl. No.: 15/096,530

(22) Filed: Apr. 12, 2016

(51) Int. Cl. A01K 15/02; A01K 27/00

(52) U.S. Cl. CPC A01K 15/023; A01K 15/029; A01K 27/009

(57) ABSTRACT

An animal training system includes a shock collar that may be worn around a neck of an animal. Thus, the shock collar is in electrical communication with the animal. The shock collar has a first transceiver. A control unit is provided and the control unit may be carried. The control unit is in communication with the shock collar. Thus, the control unit may determine a distance between the shock collar and the control unit. The control unit selectively actuates the shock collar when the shock collar moves beyond a pre-determined trigger distance from the control unit. Thus, the shock collar delivers an electric shock to the animal. The shock collar thusly informs the animal that the animal has moved beyond the pre-determined trigger distance from the control unit.

### BACKGROUND OF THE DISCLOSURE

### Field of the Disclosure

The disclosure relates to training devices and more particularly pertains to a new training device for training an animal to remain in proximity to an owner.

### SUMMARY OF THE DISCLOSURE

An embodiment of the disclosure meets the needs presented above by generally comprising a shock collar that may be worn around a neck of an animal. Thus, the shock collar is in electrical communication with the animal. The shock collar has a first transceiver. A control unit is provided and the control unit may be carried. The control unit is in communication with the shock collar. Thus, the control unit may determine a distance between the shock collar and the control unit. The control unit selectively actuates the shock collar when the shock collar moves beyond a pre-determined trigger distance from the control unit. Thus, the shock collar delivers an electric shock to the animal. The shock collar thusly informs the animal that the animal has moved beyond the pre-determined trigger distance from the control unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a control unit of an animal training system according to an embodiment of the disclosure.

FIG. 2 is a left side phantom view of a control unit of an embodiment of the disclosure.

FIG. 3 is a perspective view of a shock collar of an embodiment of the disclosure.

FIG. 4 is a top view of shock collar of an embodiment of the disclosure.

FIG. 5 is a perspective in-use view of an embodiment of the disclosure.

### DESCRIPTION OF THE PREFERRED EMBODIMENT

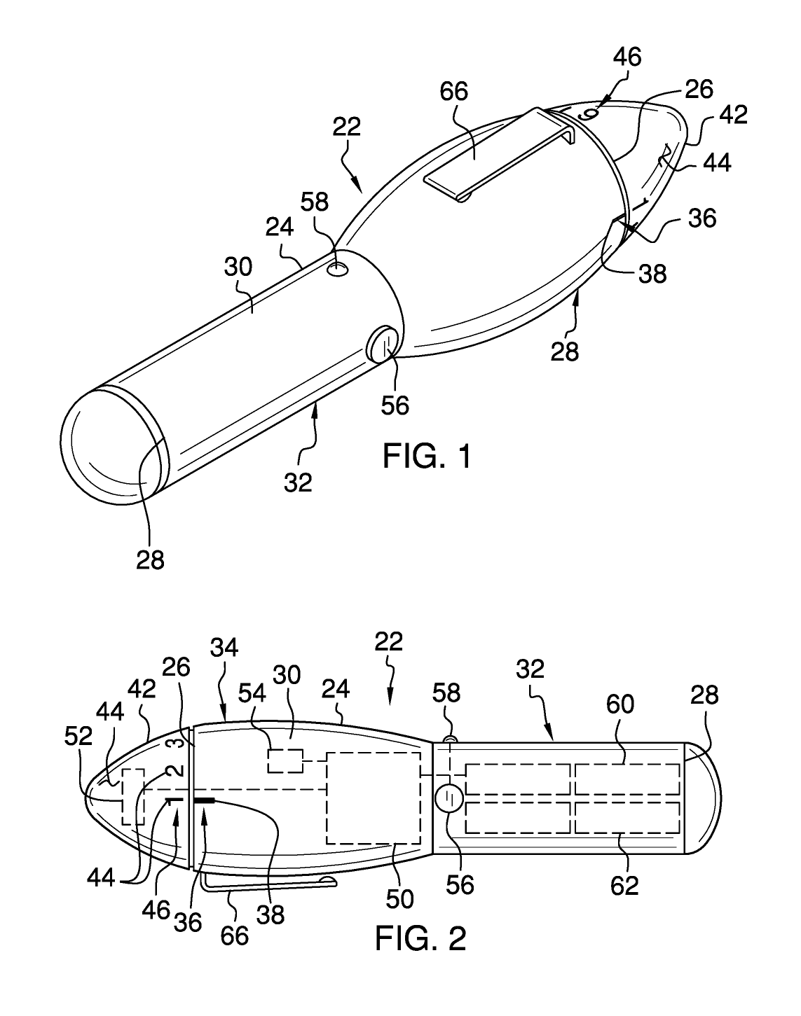

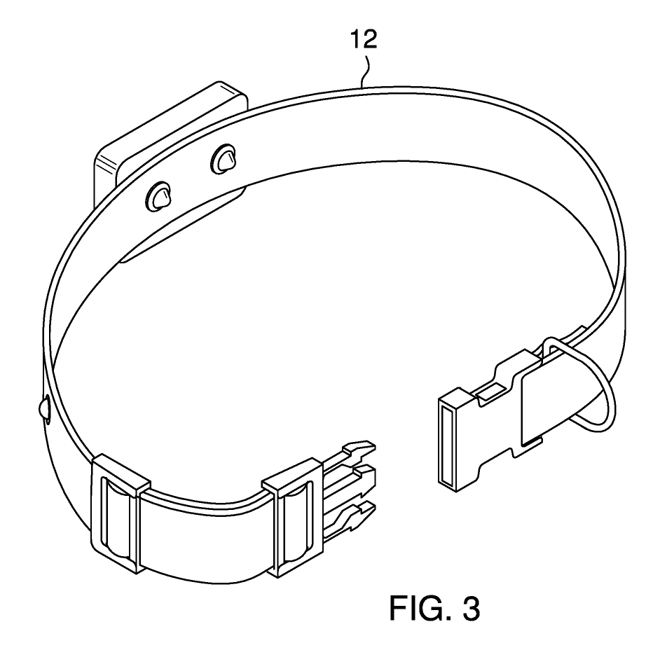

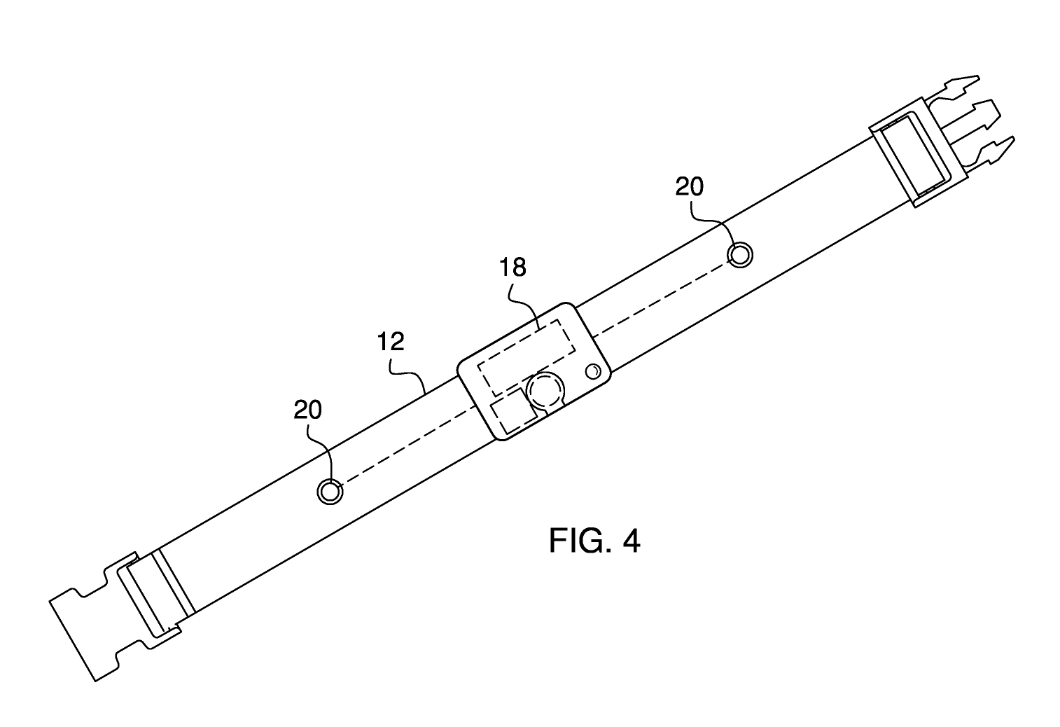

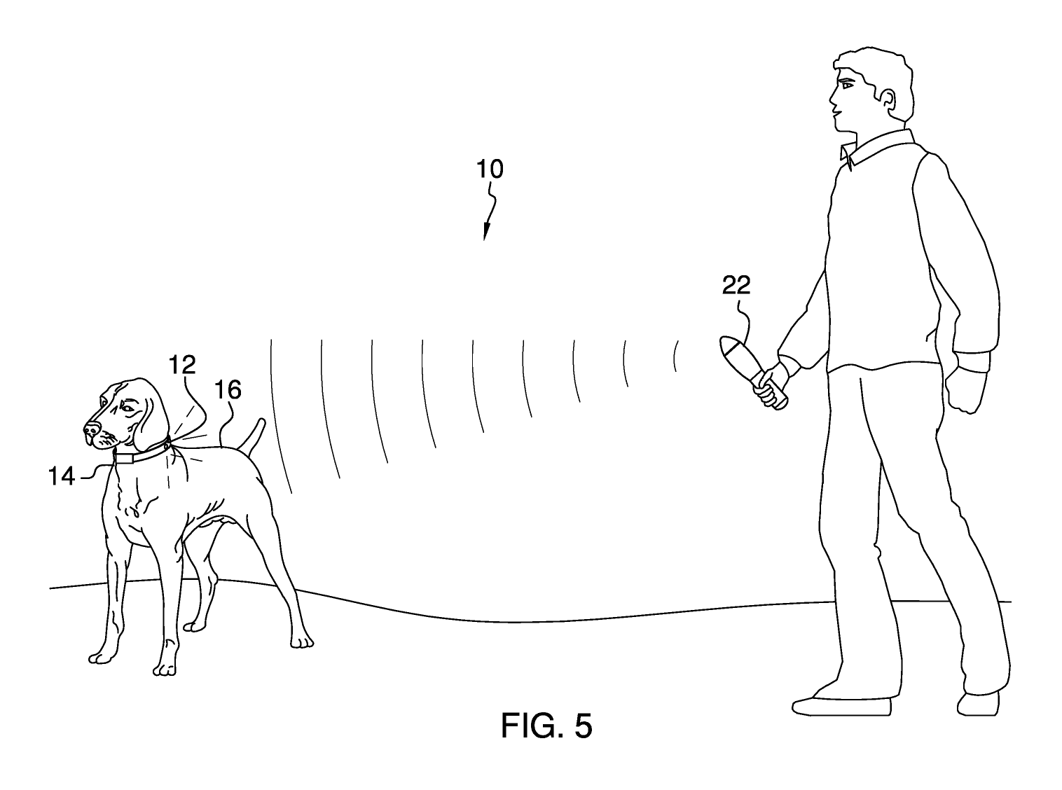

With reference now to the drawings, and in particular to FIGS. 1 through 5 thereof, a new training device embodying the principles and concepts of an embodiment of the disclosure and generally designated by the reference numeral 10 will be described.

As best illustrated in FIGS. 1 through 5, the animal training system 10 generally comprises a shock collar 12 that may be worn around a neck 14 of an animal 16. Thus, the shock collar 12 is in electrical communication with the animal 16. The shock collar 12 has a first transceiver 18. The first transceiver 18 may comprise a radio frequency transceiver or the like. The shock collar 12 may be an animal training shock collar of any conventional design. The animal 16 may be a dog or other domesticated animal.

A pair of first light emitters 20 is provided. Each of the first light emitters 20 is coupled to the shock collar 12 such that each of the first light emitters 20 is visible. Each of the first light emitters 20 is electrically coupled to the shock collar 12. Each of the first light emitters 20 emits light when the shock collar 12 is turned on. Thus, the shock collar 12 is visible at night. Each of the first light emitters 20 may comprise an LED or the like.

A control unit 22 is provided. The control unit 22 may be carried while the animal 16 is being walked or otherwise allowed to be outdoors without a leash. The control unit 22 is in communication with the shock collar 12. Thus, the control unit 22 determines a distance between the shock collar 12 and the control unit 22.

The control unit 22 selectively actuates the shock collar 12 when the shock collar 12 moves beyond a pre-determined trigger distance from the control unit 22. Thus, the shock collar 12 delivers an electric shock to the animal 16. The shock collar 12 informs the animal 16 that the animal 16 has moved beyond the pre-determined trigger distance from the control unit 22.

The control unit 22 comprises a housing 24 that may be carried. The housing 24 has a first end 26, a second end 28 and an outer wall 30 extending between the first end 26 and the second end 28. The outer wall 30 may have a first half 32 and a second half 34. The first half 32 may be gripped. The second half 34 may curve outwardly with respect to the first half 32. Thus, the second half 34 may have a substantially ovoid shape.

The outer wall 30 corresponding to the second half 34 has indicia 36 printed thereon. The indicia 36 comprise a line 38 and the line 38 is positioned adjacent to the first end 26. The second end 28 is open and the housing 24 is substantially hollow. A cap 40 is removably coupled to the second end 28.

A knob 42 is rotatably coupled to the first end 26 and the knob 42 may be manipulated. The knob 42 has an outer surface 44 and the outer surface 44 is aligned with the outer wall 30 of the housing 24. The outer surface 44 may taper to a point from the housing 24. Thus, the knob 42 may have a substantially conical shape.

Indicia 46 are printed on the outer surface 44 of the knob 42. The indicia 46 corresponding to the knob 42 comprise numbers 48. The numbers 48 are spaced apart from each other and are distributed around the knob 42. Each of the numbers 48 represents a distance ranging between a minimum distance and a maximum distance. A selected one of the numbers 48 is selectively aligned with the line on the housing 48 to establish the pre-determined trigger distance. The pre-determined trigger distance may be a distance ranging between approximately one meter and six meters.

A processor 50 is positioned within the housing 24. The knob 42 is electrically coupled to the processor 50. The processor 50 may comprise an electronic processor or the like. A second transceiver 52 is positioned within the housing 24 and the second transceiver 52 is electrically coupled to the processor 50. The second transceiver 52 is in electrical communication with the first transceiver 18. The second transceiver 52 may comprise a radio frequency transceiver or the like.

A signal strength analyzer 54 is positioned within the housing 24. The signal strength analyzer 54 is electrically coupled to the processor 50. Thus, the signal strength analyzer 54 determines a distance between the first transceiver 18 and the second transceiver 52. The processor 50 generates a shock sequence when the signal strength analyzer 54 determines the second transceiver 52 has moved beyond the pre-determined trigger distance from the first transceiver 18. The second transceiver 52 communicates the shock sequence to the first transceiver 18. Thus, the shock collar 12 delivers an electrical shock to the animal 16. The signal strength analyzer 54 may comprise an electronic signal strength analyzer or the like.

A switch 56 is coupled to the housing 24 and the switch 56 may be manipulated. The switch 56 is electrically coupled to the processor 50 such that the switch 56 turns the processor 50 on and off. A second light emitter 58 is coupled to the housing 24 and the second light emitter 58 is electrically coupled to the processor 50. The second light emitter 58 emits light when the processor 50 is turned on. The second light emitter 58 may comprise an LED or the like.

A power supply 60 is positioned within the housing 24. The power supply 60 is electrically coupled to the processor 50 and the power supply 60 comprises at least one battery 62. The power supply 60 is positioned within the first half 32 of the housing 24. The cap 64 is removed to access the at least one battery 62. A clip 66 may be coupled to the second half 34 of the housing 24. The clip 66 may engage an article of clothing or the like to store the housing 24.

In use, the shock collar 12 is worn around the neck 14 of the animal 16 and the shock collar 12 is turned on. The control unit 22 is carried while the animal 16 is walked or otherwise exercised outdoors without a leash. The knob 42 is manipulated to establish the pre-determined trigger distance. The shock collar 12 delivers the electric shock to the animal 16 when the animal 16 moves beyond the pre-determined distance from the control unit 22. Thus, the animal 16 is trained to remain in proximity to a user while the user walks the animal 16.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal training system comprising:
a shock collar being configured to be worn around a neck of an animal thereby facilitating said shock collar to be in electrical communication with the animal, said shock collar having a first transceiver; and
a control unit being configured to be carried, said control unit being in communication with said shock collar wherein said control unit is configured to determine a distance between said shock collar and said control unit, said control unit selectively actuating said shock collar when said shock collar moves beyond a pre-determined trigger distance from said control unit wherein said shock collar is configured to deliver an electric shock to the animal thereby facilitating said shock collar to inform the animal that the animal has moved beyond said pre-determined trigger distance from said control unit.

2. The system according to claim 1, wherein said control unit comprises a housing being configured to be carried, said housing having a first end, a second end and an outer wall extending between said first end and said second end, said outer wall having indicia being printed thereon, said indicia comprising a line, said line being positioned adjacent to said first end.

3. The system according to claim 2, further comprising a knob being rotatably coupled to said first end wherein said knob is configured to be manipulated, said knob having an outer surface, said outer surface being aligned with said outer wall of said housing, said outer surface having indicia being printed thereon, said indicia comprising numbers being spaced apart from each other and being distributed around said knob, each of said numbers representing a distance ranging between a minimum distance and a maximum distance, a selected one of said numbers being selectively aligned with said line on said housing to establish said pre-determined trigger distance.

4. The system according to claim 1, wherein said control unit comprises:
a housing;
a knob;
a processor being positioned within said housing, said knob being electrically coupled to said processor; and
a second transceiver being positioned within said housing, said second transceiver being electrically coupled to said processor, said second transceiver being in electrical communication with said first transceiver.

5. The system according to claim 4, further comprising a signal strength analyzer being positioned within said housing, said signal strength analyzer being electrically coupled to said processor such that said signal strength analyzer determines a distance between said first transceiver and said second transceiver, said processor generating a shock sequence when said signal strength analyzer determines said second transceiver has moved beyond said pre-determined trigger distance from said first transceiver, said second transceiver communicating said shock sequence to said first transceiver wherein said shock collar is configured to deliver an electrical shock to the animal.

6. The system according to claim 4, further comprising a switch being coupled to said housing wherein said switch is configured to be manipulated, said switch being electrically coupled to said processor such that said switch turns said processor on and off.

7. The system according to claim 4, further comprising a power supply being positioned within said housing, said power supply being electrically coupled to said processor, said power supply comprising at least one battery.

8. An animal training system comprising:
a shock collar being configured to be worn around a neck of an animal thereby facilitating said shock collar to be in electrical communication with the animal, said shock collar having a first transceiver; and
a control unit being configured to be carried, said control unit being in communication with said shock collar wherein said control unit is configured to determine a distance between said shock collar and said control unit, said control unit selectively actuating said shock collar when said shock collar moves beyond a pre-determined trigger distance from said control unit wherein said shock collar is configured to deliver an electric shock to the animal thereby facilitating said shock collar to inform the animal that the animal has moved beyond said pre-determined trigger distance from said control unit, said control unit comprising:
a housing being configured to be carried, said housing having a first end, a second end and an outer wall extending between said first end and said second end, said outer wall having indicia being printed thereon, said indicia comprising a line, said line being positioned adjacent to said first end,
a knob being rotatably coupled to said first end wherein said knob is configured to be manipulated, said knob having an outer surface, said outer surface being aligned with said outer wall of said housing, said outer surface having indicia being printed thereon, said indicia comprising numbers being spaced apart from each other and being distributed around said knob, each of said numbers representing a distance ranging between a minimum distance and a maximum distance, a selected one of said numbers being selectively aligned with said line on said housing to establish said pre-determined trigger distance,
a processor being positioned within said housing, said knob being electrically coupled to said processor,
a second transceiver being positioned within said housing, said second transceiver being electrically coupled to said processor, said second transceiver being in electrical communication with said first transceiver,
a signal strength analyzer being positioned within said housing, said signal strength analyzer being electrically coupled to said processor such that said signal strength analyzer determines a distance between said first transceiver and said second transceiver, said processor generating a shock sequence when said signal strength analyzer determines said second transceiver has moved beyond said pre-determined trigger distance from said first transceiver, said second transceiver communicating said shock sequence to said first transceiver wherein said shock collar is configured to deliver an electrical shock to the animal,
a switch being coupled to said housing wherein said switch is configured to be manipulated, said switch being electrically coupled to said processor such that said switch turns said processor on and off, and
a power supply being positioned within said housing, said power supply being electrically coupled to said processor, said power supply comprising at least one battery.
